(19) United States
(12) Patent Application Publication
(10) Pub. No.: US 2014/0199026 A1
(43) Pub. Date: Jul. 17, 2014

(54) WAVEGUIDE POWER COMBINER/SPLITTER

(71) Applicant: CMC ELECTRONIQUE INC. / CMC ELECTRONICS INC, (US)

(72) Inventors: Alan Julian Paul HNATIW, Stittsville (CA); John Patten CARR, Kanata (CA); Matthew Philip HILLS, Kanata (CA)

(73) Assignee: CMC ELECTRONIQUE INC. / CMC ELECTRONICS INC., Montreal (CA)

(21) Appl. No.: 13/743,079

(22) Filed: Jan. 16, 2013

(51) Int. Cl. G02B 6/28

(52) U.S. Cl. CPC G02B 6/28
USPC 385/48

(57) ABSTRACT

There is provided a waveguide combiner/splitter comprising an input waveguide, a first and a second waveguide matching section, and at least a first and a second output waveguide. The lengths and the widths of the matching sections may be adjusted for tuning to frequency bands of interest. The combiner/splitter may be incorporated into a corporate feed structure for use in an antenna system.

### CROSS-REFERENCE TO RELATED APPLICATIONS

This is the first application filed for the present invention.

### TECHNICAL FIELD

The present invention relates to the field of power combiners/splitters for microwave waveguide circuits.

### BACKGROUND OF THE ART

A waveguide feed and radiator element combination may be used in a radiating mode to enable an antenna to receive energy from a single waveguide and convey the energy to a large area. The antenna may also be used in reverse, i.e. in a receive mode, to collect energy from the large area and convey the collected energy to the single input/output waveguide. The feed may be created using a series of splits that fan-out a signal to the respective radiator elements of the antenna. For this purpose, a power splitter may be used to split input signals received thereat and route the split signal components to various parts of the waveguide circuit. In particular, series of cascaded power splitters, e.g. 1×2 splitters, may be used. When used in reverse, power splitters may function as combiners for combining a plurality of input signals into a single output signal component.

Conventional waveguide power splitters or combiners may use input or output ports, which as positioned at ninety degree bends to a main axis of an apparatus. However, such power splitters require extensive tuning at each port to minimize loss, resulting in increased manufacturing costs. In addition, although it is well known that narrowband power splitters, e.g. achieving 5-10% bandwidth, may be realized using relatively simple means, it becomes difficult to achieve a broadband response, e.g. 25-50% bandwidth, without additional complexity.

There is therefore a need for an improved waveguide power combiner/splitter.

### SUMMARY

In accordance with a first broad aspect, there is provided a power splitter comprising an input waveguide for receiving an input signal thereat, at least a first waveguide matching section coupled to the input waveguide and a second waveguide matching section coupled to the first waveguide matching section, at least one of a first length of the first waveguide matching section, a first width of the first waveguide matching section, a second length of the second waveguide matching section, and a second width of the second waveguide matching section selected for providing impedance matching over at least one frequency band of interest, and a plurality of output waveguides each coupled to the second waveguide matching section, the input signal adapted to propagate from the input waveguide towards the second waveguide matching section and to be separated thereat into a plurality of output signals for output by corresponding ones of the plurality of output waveguides.

In accordance with a second broad aspect, there is provided a multi-stage power splitter having a plurality of single-stage power splitters arranged in a tree hierarchy, each one of the plurality of single-stage power splitters comprising an input waveguide for receiving an input signal thereat, at least a first waveguide matching section coupled to the input waveguide and a second waveguide matching section coupled to the first waveguide matching section, at least one of a first length of the first waveguide matching section, a first width of the first waveguide matching section, a second length of the second waveguide matching section, and a second width of the second waveguide matching section selected for providing impedance matching over at least one frequency band of interest, and a plurality of output waveguides each coupled to the second waveguide matching section, the input signal adapted to propagate from the input waveguide towards the second waveguide matching section and to be separated thereat into a plurality of output signals for output by corresponding ones of the plurality of output waveguides.

### BRIEF DESCRIPTION OF THE DRAWINGS

Further features and advantages of the present invention will become apparent from the following detailed description, taken in combination with the appended drawings, in which:

FIG. 1 is a schematic diagram of a 1×2 waveguide combiner/splitter in accordance with an illustrative embodiment of the present invention;

FIG. 2 is a plot of the simulated return loss of the 1×2 waveguide combiner/splitter of FIG. 1;

FIG. 3a is a schematic diagram of a 1×4 corporate feed structure comprising a plurality of the 1×2 waveguide combiner/splitter of FIG. 1; and

FIG. 3b is a detailed schematic diagram of the 1×4 corporate feed structure of FIG. 3a.

It will be noted that throughout the appended drawings, like features are identified by like reference numerals.

### DETAILED DESCRIPTION

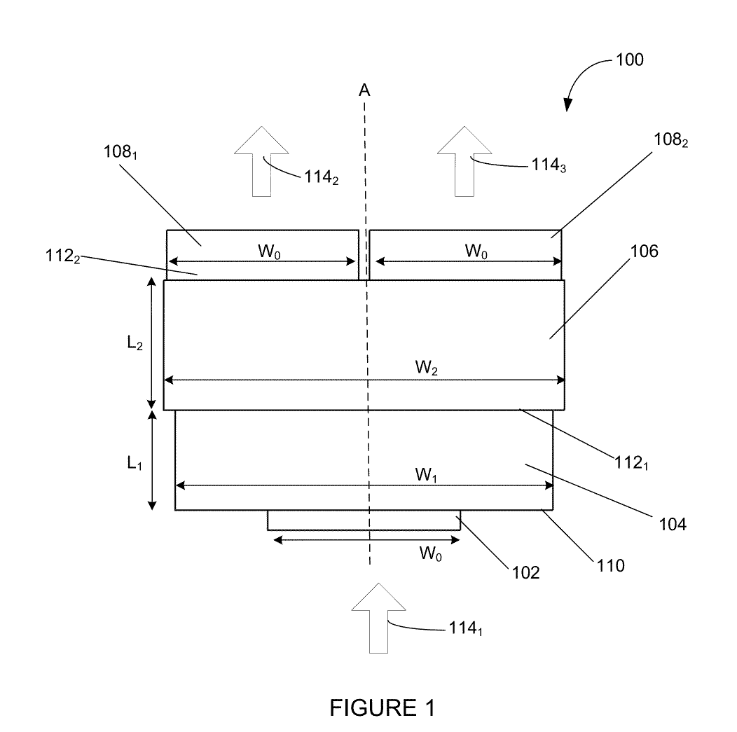

Referring now to FIG. 1, a waveguide power combiner/splitter 100 will now be described. The waveguide combiner/splitter 100 may be integrated with an antenna or an antenna array (not shown) for transmitting and receiving signals having frequencies within a frequency band of interest. The waveguide combiner/splitter 100 may be realized using manufacturing processes, such as conventional machining, extrusion, molding, or others known to those skilled in the art. The waveguide combiner/splitter 100 may be designed for use in either the E-plane or the H-plane.

The waveguide combiner/splitter 100 may be used in a microwave waveguide circuit (not shown) to combine or separate feeds received at the waveguide combiner/splitter 100 for subsequent routing to remaining parts of the circuit. For example, the waveguide combiner/splitter 100 may be used to combine signals from a plurality of lower power devices (not shown) to form a high power signal for transmission through a single antenna (not shown). Alternatively, the waveguide combiner/splitter 100 may be used to divide a signal from a single input into a plurality of signals for multiple corresponding radiator elements (not shown).

In one embodiment and as will be discussed further below, the waveguide combiner/splitter 100 splits the power of a single input feed received from a source into a first feed and a second feed, which may in turn be supplied to a first and a second radiator element of the antenna array the waveguide combiner/splitter 100 is coupled to. For this purpose, the waveguide combiner/splitter 100 illustratively comprises an input waveguide 102, a first waveguide matching section 104, a second waveguide matching section 106, and two (2) output waveguides 108₁ and 108₂. While the waveguide combiner/splitter 100 is described herein as a 1×2 power divider, it should be understood that the waveguide combiner/splitter 100 may be used in reverse as a 2×1 power combiner for combining two (2) separate input feeds. For this purpose, the output waveguides 108₁ and 108₂ may be provided as two (2) inputs to the waveguide combiner/splitter 100 and the input waveguide 102 as a single output.

The input waveguide 102, the waveguide matching sections 104 and 106, and the output waveguides 108₁ and 108₂ are illustratively metal-walled and have a rectangular cross-section. It should be understood that the input waveguide 102, the waveguide matching sections 104 and 106, and the output waveguides 108₁ and 108₂ may each be provided with radiused rather than sharp corners (not shown). In this manner, manufacturing by injection moulding, machining, or the like may be eased. It should also be understood that other configurations may apply. The input waveguide 102, the waveguide matching sections 104 and 106, and the output waveguides 108₁ and 108₂ may each comprise a waveguide (not shown) configured to guide a signal therein and a conductive, e.g. metallic, boundary (not shown) surrounding the waveguide. The waveguide may have an air-filled or other appropriate structure, such as a dielectric-filled or partially-dielectric filled waveguide structure.

The input waveguide 102 may be coupled to the first waveguide matching section 104 through a first end 110 thereof. The first waveguide matching section 104 may further comprise a second end (not shown), which is opposite to the first end 110 and coupled to a first end 112₁ of the second waveguide matching section 106. The second waveguide matching section 106 may further comprise a second end 112₂, which is opposite to the first end 112₁ and from which the output waveguides 108₁ and 108₂ extend outwardly. The output waveguides 108₁ and 108₂ are thus coupled to the second waveguide matching section 106. The input waveguide 102 and the waveguide matching sections 104 and 106 illustratively have a common center line A. The output waveguides 108₁ and 108₂ are illustratively symmetrical to each other with respect to the center line A and extend along a direction substantially parallel thereto. Still, it should be understood that the output waveguides 108₁ and 108₂ may be asymmetric with respect to the center line A. As will be discussed further below, an electromagnetic signal received at the input waveguide 102 may then travel through the first waveguide matching section 104, the second waveguide matching section 106, and towards each one of the output waveguides 108₁ and 108₂.

The input waveguide 102 and the output waveguides 108₁ and 108₂ illustratively have a same width W₀, with the width W₀ being smaller than the width W₂ of the second waveguide matching section 106. In particular, in order to couple the output waveguides 108₁ and 108₂ to the second waveguide matching section 106, the sum of the widths W₀ of the output waveguides 108₁ and 108₂ is illustratively smaller than the width W₂. In addition, the width W₀ is illustratively smaller than the width W₁ of the first waveguide matching section 104, which may in turn be smaller than the width W₂ of the second waveguide matching section 106. As a result, the width of the input waveguide 102 is physically diverged from the first dimension W₀ to the second dimension W₁. As known to those skilled in the art, this width spreading illustratively accomplishes impedance matching. Impedance matching may be further achieved by the gradual change in dimension between the width W₁ of the first waveguide matching section 104 and the width W₂ of the second waveguide matching section 106. In this manner, maximum power transfer between the input waveguide 102 and the first and second waveguide matching sections 104, 106 can be achieved. It should be understood that the widths W₀, W₁, and W₂ may be chosen according to impedance matching requirements. As such, various configurations may apply. In addition, in some embodiments, more than two (2) waveguide matching sections 104, 106 may be used.

Still referring to FIG. 1, the input waveguide 102 may be coupled to a source (not shown) of electromagnetic signals, such as high frequency radio waves or microwaves. The waveguide combiner/splitter 100 may thus receive an input signal 114₁ at the input waveguide 102. The input signal 114₁ illustratively enters the input waveguide 102 and conducts itself along the center line A through the first and the second waveguide matching sections 104 and 106. Impedance matching is achieved by the spreading from width W₀ to widths W₁ and W₂, as discussed above. The signal (not shown) traveling through the second waveguide matching section 106 is then guided through the first output waveguide 108₁ and the second output waveguide 108₂ as a first component 114₂ and a second component 114₃. In one embodiment, the first and second output signals 114₂ and 114₃ are equal in magnitude and balanced in phase. It should however be understood that the waveguide combiner/splitter 100 may be designed such that the first and second output signals 114₂ and 114₃ are unequal in magnitude and/or phase. For instance, in some applications, it may be desirable for the output signals 114₂ and 114₃ to be out of phase by ninety (90) degrees. Moreover, providing output signals 114₂ and 114₃ that are unequal in magnitude may enable for non binary power combination/splits. For example, when unequal outputs are provided, the waveguide combiner/splitter 100 may achieve 1×3 power splits. The waveguide combiner/splitter 100 providing unequal 1×2 power splits may further be used in a corporate feed along with additional splitters (not shown) to achieve 1×3 power splits. It should be understood that any number, e.g. N, with N an integer, of output signals may be provided, thus resulting in the waveguide combiner/splitter 100 providing 1×N power splits. The waveguide combiner/splitter 100 may accordingly comprise more than two (2) output waveguides as in 108₁ and 108₂.

The waveguide combiner/splitter 100 illustratively uses a first and a second waveguide matching section 104 and 106, which are designed so as to achieve a broadband response with two well-spaced frequency bands. In particular, although the heights (not shown) thereof are illustratively provided so as to be uniform and predetermined, the lengths L₁ and L₂ and the widths W₁ and W₂ of the waveguide matching sections 104, 106 may be varied rather than being set to a fixed predetermined value, e.g. quarter wavelength. In this manner, impedance matching over a frequency band of interest may be achieved. As such, the impedances of the matching waveguide sections 104, 106, and thus the waveguide combiner/splitter 100, may be tailored to a variety of applications. In particular, a compact waveguide combiner/splitter 100 ensuring low loss splitting of the output signal can be obtained. The size and weight of the overall antenna end product may in turn be minimized.

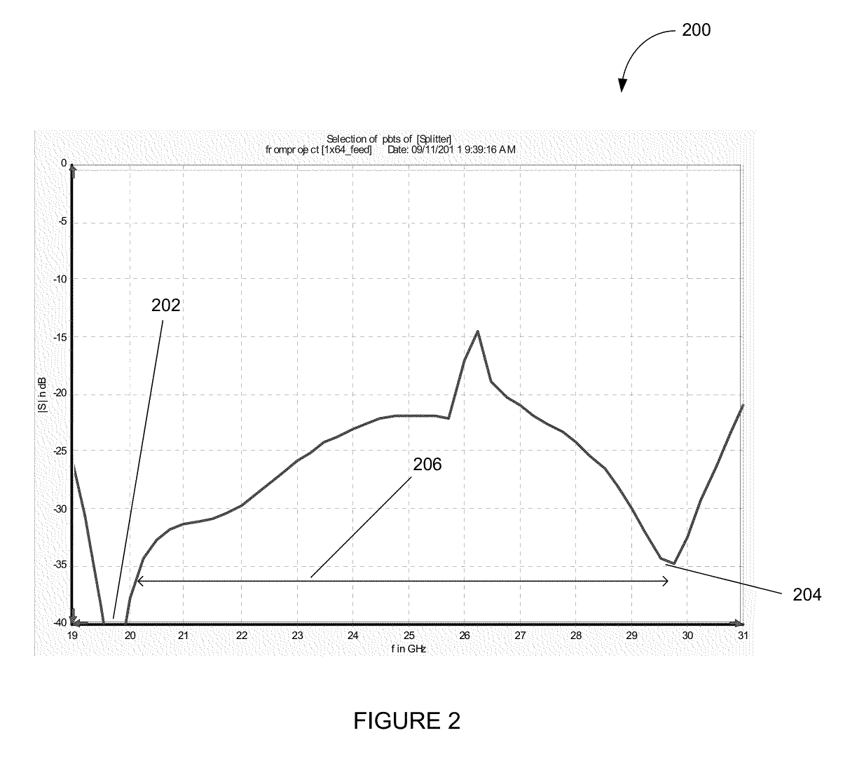

For example, and as illustrated in FIG. 2, the lengths L₁ and L₂ and the widths W₁ and W₂ of the waveguide matching sections 104, 106 may be optimized so as to provide good matching over a large passband, e.g. the Ka-band with a broad frequency range from about 20 GHz to about 30 GHz. It should be understood that other frequency ranges may apply. The waveguide combiner/splitter 100 of FIG. 1 may therefore be tuned to a frequency of interest. The plot 200 of FIG. 2 shows the simulated return loss for the waveguide combiner/splitter 100. As illustrated on plot 200, the lengths L₁ and L₂ and the widths W₁ and W₂ may be set so as to obtain two (2) widely spaced narrowband responses, namely a receive frequency band 202 and a transmit frequency band 204. In particular, the position of the frequency bands 202 and 204 may be adjusted by setting different values for the lengths L₁ and L₂ and the widths W₁ and W₂. It should be understood the dimensions of both or a single one of the waveguide matching sections 104, 106 may be varied. It should also be understood that at least one of the length L₁ or L₂ and the width W₁ or W₂ may be varied. It should further be understood that the two bands 202, 204 may both be receive or transmit bands. In the embodiment illustrated in FIG. 2, the waveguide matching section 104 is provided with a length L₁ of 5.5 mm and a width W₁ of 17.8 mm while the waveguide matching section 106 is provided with a length L₂ of 6.4 mm and a width W₂ of 20.1 mm. As a result, the receive frequency band 202 is centered at substantially 20 GHz while the transmit frequency band 204 is centered at substantially 30 GHz. The bands 202 and 204 are illustratively narrow with a bandwidth of substantially 2 GHz and are separated by a wide frequency passband 206.

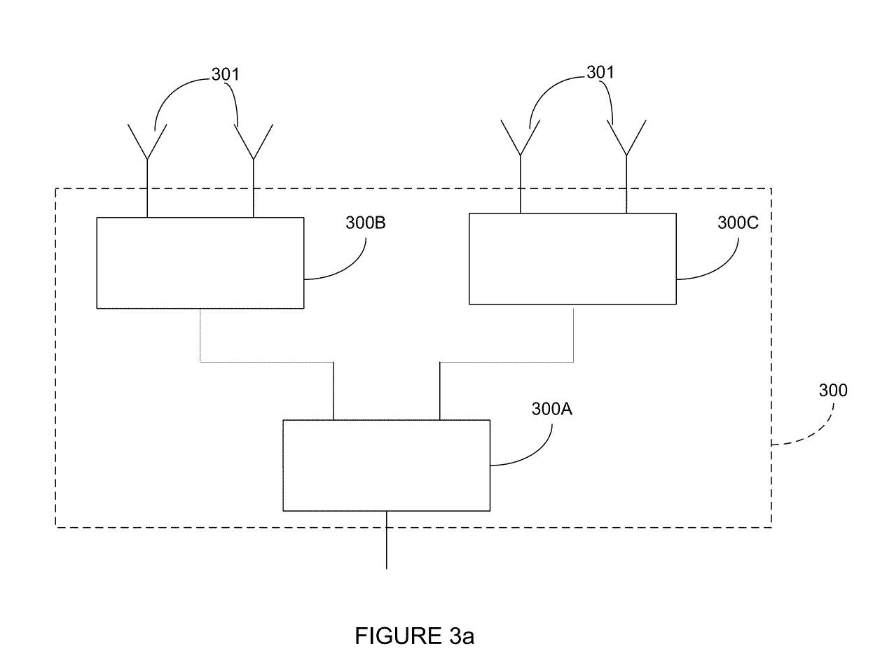

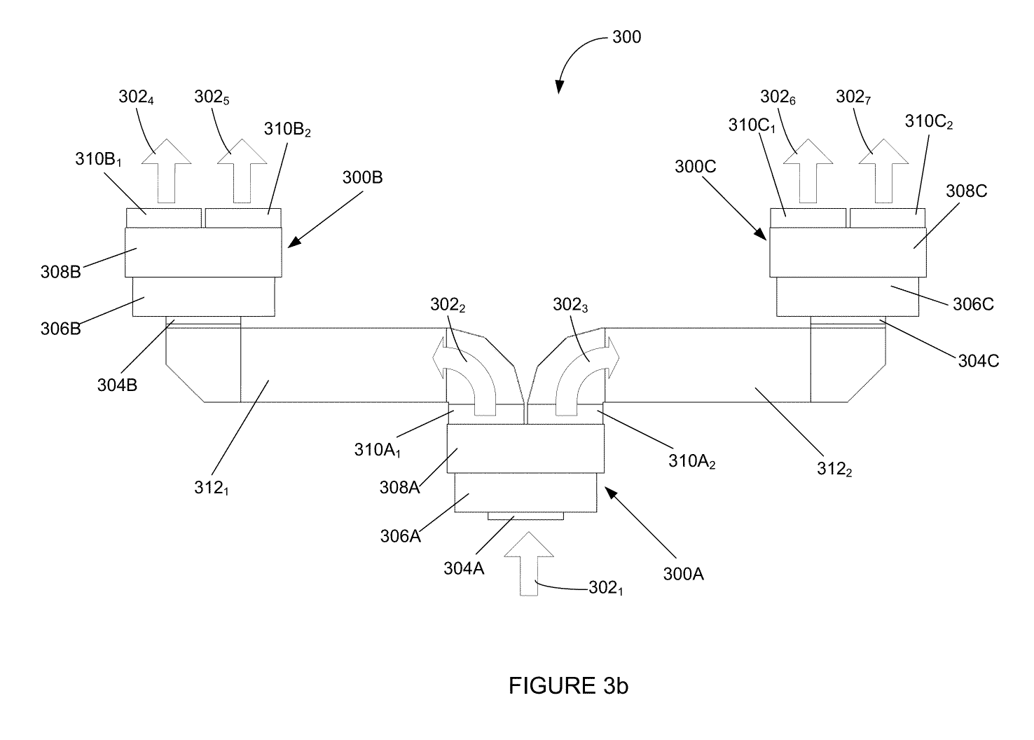

FIG. 3a shows an example of the incorporation of the 1×2 waveguide combiner/splitter (reference 100 in FIG. 1) into a 1×4 corporate feed structure 300 adapted for use in an antenna system (not shown), e.g. a line source or antenna aperture. In particular, the 1×4 corporate feed structure 300 may be used to fan-out a signal (not shown) received thereat and feed individual radiator elements as in 301 of the antenna system. The 1×4 corporate feed structure 300 may be realized by combining two stages of the 1×2 waveguide combiner/splitter 100 in a tree hierarchy. In the embodiment illustrated in FIG. 3a, three (3) 1×2 waveguide splitters 300A, 300B, and 300C are used in two (2) successive stages to create a multi-stage power splitter. It should be understood that a multi-stage power combiner may also be achieved by combining successive stages of the waveguide splitters 300A, 300B, and 300C used in reverse as waveguide combiners.

Referring to FIG. 3b in addition to FIG. 3a, the first waveguide splitter 300A illustratively receives an input signal 302₁ at an input waveguide 304A thereof. The input signal 302₁ may then propagate through the first waveguide matching section 306A and the second waveguide matching section 308A prior to being split into a first component 302₂ and a second component 302₃. The first component 302₂ may be output by a first output waveguide 310A₁ while the second component 302₃ may be output by a second output waveguide 310A₂.

A first output line or junction 312₁ may further couple the first output waveguide 310A₁ of the first waveguide splitter 300A to an input waveguide 304B of the second waveguide splitter 300B. Similarly, a second output line 312₂ may couple the second output waveguide 310A₂ of the first waveguide splitter 300A to an input waveguide 3040 of the third waveguide splitter 3000. In this manner, the first signal component 302₂ output by the first waveguide splitter 300A may be fed to the second waveguide splitter 300B while the second component 302₃ output by the first waveguide splitter 300A may be fed to the third waveguide splitter 3000.

The input signal 302₂ received at the input waveguide 304B may then propagate through the first waveguide matching section 306B and the second waveguide matching section 308B of the second waveguide splitter 300B. The signal may then be split into a first component 302₄ and a second component 302₅, which may respectively be output by a first output waveguide 310B₁ and a second output waveguide 310B₂. The components 302₄ and 302₅ may then be fed to corresponding radiator elements 301. Similarly, the input signal 302₃ received at the input waveguide 3040 may propagate through the first waveguide matching section 3060 and the second waveguide matching section 3080 of the third waveguide splitter 3000. The signal may then be split into a first component 302₆ and a second component 302₇, which may be respectively output by a first output waveguide 310C₁ and a second output waveguide 310C₂. The components 302₆ and 302₇ may then be fed to corresponding radiator elements 301.

In this manner, the corporate feed structure 300 enables separation of the input signal 302₁ into four (4) distinct components 302₄, 302₅, 302₆, and 302₇. It should be understood that, by increasing the number of waveguide combiner/splitters as in 300B and 300C and the number of junctions, as in 312₁ and 312₂, a multi-stage power splitter having an arbitrary number of output signals as in 302₄, 302₅, 302₆, and 302₇, and accordingly an arbitrary number of output ports, may be obtained.

Referring back to FIG. 1, by adjusting the dimensions of the waveguide matching sections 104, 106 of the waveguide combiner/splitter 100, compactness may be achieved and the size and weight of the overall antenna system may in turn be reduced. In addition, by precisely tuning the dimensions of the waveguide matching sections 104, 106 to a frequency of interest, non-standard impedances providing low return loss over a broad bandwidth may be obtained.

The embodiments of the invention described above are intended to be exemplary only. The scope of the invention is therefore intended to be limited solely by the scope of the appended claims.

1. A power splitter comprising:
an input waveguide for receiving an input signal thereat;
at least a first waveguide matching section coupled to the input waveguide and a second waveguide matching section coupled to the first waveguide matching section, at least one of a first length of the first waveguide matching section, a first width of the first waveguide matching section, a second length of the second waveguide matching section, and a second width of the second waveguide matching section selected for providing impedance matching over at least one frequency band of interest; and
a plurality of output waveguides each coupled to the second waveguide matching section, the input signal adapted to propagate from the input waveguide towards the second waveguide matching section and to be separated thereat into a plurality of output signals for output by corresponding ones of the plurality of output waveguides.

2. The power splitter of claim 1, wherein the input waveguide, the first waveguide matching section, the second waveguide matching section, and the plurality of output waveguides each comprise a waveguide surrounded by a conductive boundary and have a rectangular cross-section.

3. The power splitter of claim 2, wherein the conductive boundary is metallic and the waveguide is one of air-filled, partially-dielectric filled, and dielectric-filled.

4. The power splitter of claim 1, wherein the input waveguide, the first waveguide matching section, and the second waveguide matching section extend along a common center line.

5. The power splitter of claim 4, wherein the plurality of output waveguides are positioned symmetrically to the center line and extend along a direction substantially parallel thereto.

6. The power splitter of claim 4, wherein the plurality of output waveguides are positioned asymmetrically to the center line and extend along a direction substantially parallel thereto.

7. The power splitter of claim 1, wherein the at least one of the first length, the first width, the second length, and the second width are selected to provide impedance matching over a broad frequency range comprising at least a first frequency band and a second frequency band separated by a wide frequency passband.

8. The power splitter of claim 7, wherein the at least one of the first length, the first width, the second length, and the second width are selected to center the first frequency band at substantially 20 GHz and the second frequency band at substantially 30 GHz, the first frequency band and the second frequency band each having a bandwidth of substantially 2 GHz.

9. The power splitter of claim 7, wherein the first width and the second width are greater than a third width of the input waveguide, thereby achieving the impedance matching.

10. The power splitter of claim 1, wherein the plurality of output signals output by the plurality of output waveguides have one of an equal magnitude and an unequal magnitude and one of an equal phase and an unequal phase.

11. The power splitter of claim 1, wherein the power splitter has one of an E-plane geometry and an H-plane geometry.

12. The power splitter of claim 1, wherein the power splitter is adapted to be used in reverse as a power combiner by providing a plurality of input signals to the plurality of output waveguides, combining the plurality of input signals at the second waveguide matching section, and outputting an output signal at the input waveguide.

13. A multi-stage power splitter having a plurality of single-stage power splitters arranged in a tree hierarchy, each one of the plurality of single-stage power splitters comprising:
an input waveguide for receiving an input signal thereat;
at least a first waveguide matching section coupled to the input waveguide and a second waveguide matching section coupled to the first waveguide matching section, at least one of a first length of the first waveguide matching section, a first width of the first waveguide matching section, a second length of the second waveguide matching section, and a second width of the second waveguide matching section selected for providing impedance matching over at least one frequency band of interest; and
a plurality of output waveguides each coupled to the second waveguide matching section, the input signal adapted to propagate from the input waveguide towards the second waveguide matching section and to be separated thereat into a plurality of output signals for output by corresponding ones of the plurality of output waveguides.

14. The multi-stage power splitter of claim 13, wherein the at least one of the first length, the first width, the second length, and the second width are selected to provide impedance matching over a broad frequency range comprising at least a first frequency band and a second frequency band separated by a wide frequency passband.

15. The multi-stage power splitter of claim 13, wherein the plurality of output signals output by the plurality of output waveguides have one of an equal magnitude and an unequal magnitude and one of an equal phase and an unequal phase.

16. The multi-stage power splitter of claim 13, having a first single-stage power splitter adapted to receive the input signal and output a first and a second output signals, a second single-stage power splitter coupled to the first single-stage power splitter and adapted to receive the first output signal and output a third and a fourth output signal, and a third single-stage power splitter coupled to the first single-stage power splitter and adapted to receive the second output signal and output a fifth and a sixth output signal.

17. The multi-stage power splitter of claim 13, wherein each single-stage power splitter is adapted to be used in reverse as a single-stage power combiner by providing a plurality of input signals to the plurality of output waveguides, combining the plurality of input signals at the second waveguide matching section, and outputting an output signal at the input waveguide.
